(19) United States
(12) Patent Application Publication
(10) Pub. No.: US 2010/0125577 A1
(43) Pub. Date: May 20, 2010

(54) Extending Distribution Lists

(75) Inventors: Marc Dreyfus, Brooklyn, NY (US); Asima Silva, Holden, MA (US); Ping Wang, Westford, MA (US); Robert Cameron Weir, Westford, MA (US)

Correspondence Address: CANTOR COLBURN LLP - IBM LOTUS, 20 Church Street, 22nd Floor, Hartford, CT, 06103, US

(73) Assignee: International Business Machines Corporation, Armonk, NY (US)

(21) Appl. No.: 12/273,582

(22) Filed: Nov. 19, 2008

(51) Int. Cl. G06F 17/30

(52) U.S. Cl. 707/736; 707/E17.046

(57) ABSTRACT

A method including determining a set of clusters of person records from a data source that includes the person records, where the person records include attributes and person identifiers that correspond to the attributes; determining memberships of the person records to the clusters based on a correlation of the attributes across the person records; searching the person identifiers of the person records in the memberships for matches to existing person identifiers in a distribution list; and for the memberships that include person identifiers that are matches to the existing person identifiers, suggesting other person identifiers from these memberships to be added to the existing person identifiers in the distribution list to extend the distribution list.

### BACKGROUND

This invention relates generally to distribution lists, and particularly to extending distribution lists.

Distribution lists are used in various applications, such as electronic messaging (e.g., email, chat, texting, etc.), scheduling (e.g., for meetings, conferences, etc.), collaboration (e.g., team spaces), etc., to provide a list of recipients, participants, or other common members. Distribution lists may be predetermined or created at the moment (e.g., by entering names in a recipient field), but in either case, there may be a desire to add additional members to the list. For example, an employee may need to distribute an email seeking assistance in a particular area of expertise. Usually, the employee can rely on limited sources to obtain an effective distribution list, such as the employee's knowledge or past experience of other employees with such expertise, one or more predetermined distribution lists (which are often old or insufficient), or employee databases or catalogs (which may also be old or insufficient and can be time-consuming to search). Thus, it would be desirable to the employee to be able to efficiently extend the distribution list.

### BRIEF SUMMARY

Extending distribution lists is provided. An exemplary method embodiment includes determining a set of clusters of person records from a data source that includes the person records, where the person records include attributes and person identifiers that correspond to the attributes; determining memberships of the person records to the clusters based on a correlation of the attributes across the person records; searching the person identifiers of the person records in the memberships for matches to existing person identifiers in a distribution list; and for the memberships that include person identifiers that are matches to the existing person identifiers, suggesting other person identifiers from these memberships to be added to the existing person identifiers in the distribution list to extend the distribution list.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured to extend distribution lists.

FIG. 2 is a block diagram illustrating an example of extending a distribution list, as performed, for example, by the exemplary computing device of FIG. 1.

FIG. 3 is a flow diagram illustrating an example of a method to extend distribution lists, which is executable, for example, on the exemplary computing device of FIG. 1.

The detailed description explains the preferred embodiments of the invention, together with advantages and features, by way of example with reference to the drawings.

### DETAILED DESCRIPTION

According to exemplary embodiments of the invention described herein, extending distribution lists is provided. In accordance with such exemplary embodiments, distribution lists for applications such as electronic messaging, scheduling, or collaboration are extended (or augmented) by calculating common attributes (such as expertise, background, skills, etc.) among existing members of a distribution list and suggesting additional members for the distribution list who have similar combinations of attributes.

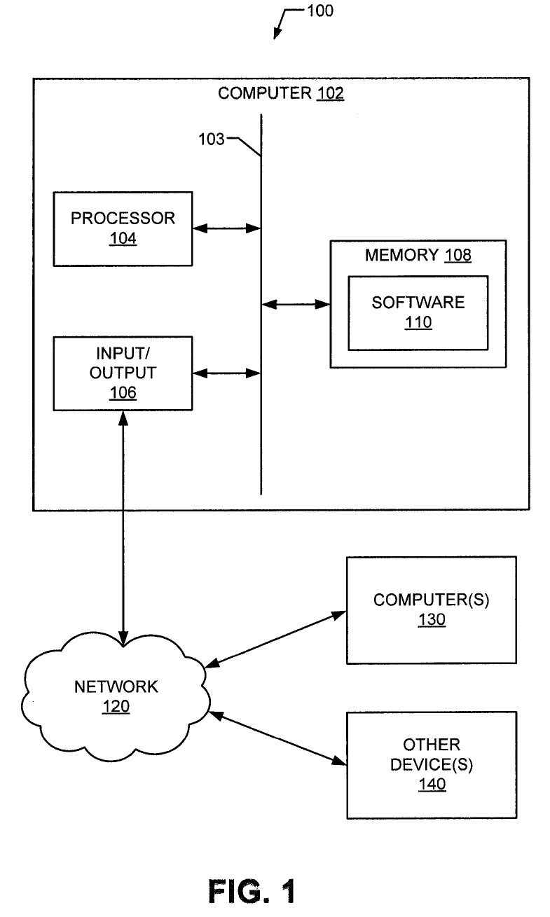

Turning now to the drawings in greater detail, wherein like reference numerals indicate like elements, FIG. 1 illustrates an example of a computer system 100 including an exemplary computing device (“computer”) 102 configured to extend distribution lists. In addition to computer 102, exemplary computer system 100 includes network 120, computing device(s) (“computer(s)”) 130, and other device(s) 140. Network 120 connects computer 102, computer(s) 130, and other device(s) 140 and may include one or more wide area networks (WANs) and/or local area networks (LANs) such as the Internet, intranet(s), and/or wireless communications network(s). Computer(s) 130 may include one or more other computers, e.g., that are similar to computer 102 and which, e.g., may operate as a server device, client device, etc. within computer system 100. Other device(s) 140 may include one or more other computing devices that provide data storage and/or other computing functions. Computer 102, computer(s) 130, and other device(s) 140 are in communication via network 120, e.g., to communicate data between them.

Exemplary computer 102 includes processor 104, input/output component(s) 106, and memory 108, which are in communication via bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from computer 102, such as a display, keyboard, modem, network adapter, ports, etc. (not depicted). Memory 108 includes software 110 configured to extend distribution lists, which is executable, e.g., by computer 102 via processor 104. Memory 108 may include other software, data, etc. (not depicted).

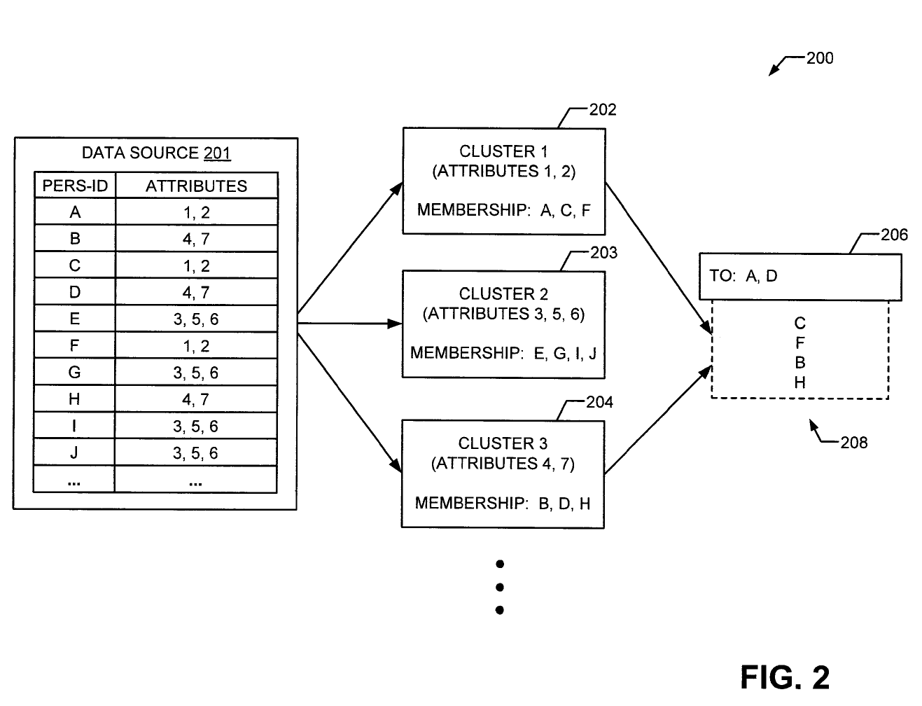

FIG. 2 illustrates an exemplary diagram 200 of extending a distribution list 206, as performed, for example, by the exemplary computing device 102 of FIG. 1. Exemplary diagram 200 includes a set of clusters 202, 203, 204 of “person records”, which include one or more attributes 1, 2, 3, 4, 5, 6, 7 and “person identifiers” A, B, C, D, E, F, G corresponding to the attributes 1, 2, 3, 4, 5, 6, 7. A “person identifier” may be a name, identification number (e.g., employee number, social security number, etc.), or other key that can be used to uniquely identify a person. Clusters 202, 203, 204 may be obtained by a clustering algorithm (e.g., K-means, Fuzzy C-means, Hierarchical, or Mixture of Gaussians) executed (performed, conducted, etc.) on a data source 201 (e.g., a lightweight directory access protocol (LDAP) directory, a listing of project involvement, a listing of authoring of articles or publications, a listing of past or current team membership of employees, or a listing of a frequency of emailing or short-term conversations between employees). Data source 201 includes the person records. For example, each row of data source 201 can represent a person record. The clusters 202, 203, 204 include memberships of the person records based on a correlation of the attributes 1, 2, 3, 4, 5, 6, 7 across the person records.

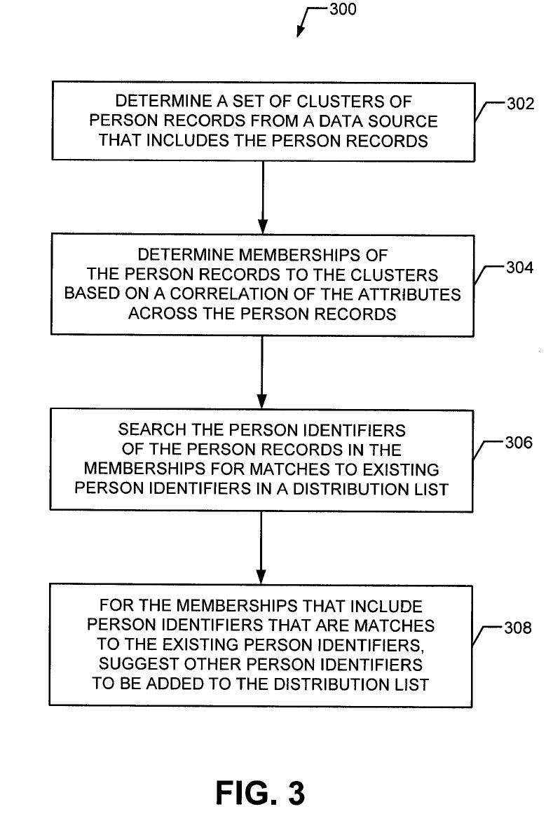

Exemplary diagram 200 also includes an entered or predetermined distribution list 206 (e.g., a “To”, “Cc”, etc. field of an email, conference invitation, etc.), which includes person identifiers A, D. Adjacent to distribution list 206 (e.g., in the form of a drop-down window) is a suggested extended distribution list 208, which includes person identifiers C, F, B, H. The extended distribution list 208 is based on a search of clusters 202, 203, 204 for matches to person identifiers A, D in the distribution list 206, where the extended distribution list 208 includes person identifiers C, F, B, H, which have memberships in clusters 202, 204 that also include memberships of person identifiers A, D. An exemplary operation with respect to diagram 200 is described below with respect to FIG. 3.

FIG. 3 illustrates an example of a method 300 to extend distribution lists, which is executable, for example, on the exemplary computer 102 of FIG. 1 (e.g., as a computer program product). Exemplary method 300 may also describe an exemplary operation to extend distribution lists, e.g., by exemplary computer 102, as illustrated, e.g., in the exemplary diagram 200 of FIG. 2. In block 302, a set of clusters of person records is determined from a data source that includes the person records, where the person records include attributes and person identifiers that correspond to the attributes. As discussed above, a person identifier may be a name, identification number (e.g., employee number, social security number, etc.), or other key that can be used to uniquely identify a person. In some embodiments, the determining in block 302 includes determining a set of clusters of person records that include attributes that are based on a lightweight directory access protocol (LDAP), a listing of project involvement, a listing of authoring of articles or publications, past or current team membership of employees, or a frequency of emailing or short-term (ST) conversations between employees. In some embodiments, the determining in block 302 includes determining a set of person records that are obtained from a data source such as a lightweight directory access protocol (LDAP) directory, a listing of project involvement, a listing of authoring of articles or publications, a listing of past or current team membership of employees, or a listing of a frequency of emailing or short-term conversations between employees.

In block 304, memberships of the person records to the clusters are determined based on a correlation of the attributes across the person records. In some embodiments, determining the set of clusters (i.e., in block 302) and determining the memberships (i.e., in block 304) includes executing (performing, conducting, etc.) a clustering algorithm (clustering analysis, data clustering, etc.) such as a K-means, Fuzzy C-means, Hierarchical, or Mixture of Gaussians clustering algorithm on the data source. For example, in the case of an company LDAP data source, the resulting clusters will each contain a set of people (e.g., identified by their names) who have more in common with each other than they have with others in the company, where commonality is defined by the attributes from the company LDAP data source and/or other sources (such as those discussed for block 302). Furthermore, e.g., each cluster may be a table, or two or more clusters may be included in a common table. Additionally, in some embodiments, determining the set of clusters and determining the memberships is conducted offline (e.g., other than real-time or during runtime) and/or is periodically repeated to update the clusters and the memberships.

In some embodiments, determining the set of clusters (i.e., in block 302) and determining the memberships (i.e., in block 304) may be performed in advance (e.g., a predetermining). Furthermore, in some embodiments (such as the foregoing), the determined clusters and memberships can be stored for future searches. For example, the clusters and memberships may be stored on one or more servers (e.g., computer(s) 130), on one or more clients (e.g., computer 102 and/or computer(s) 130), or in any other accessible manner.

In block 306, the person identifiers of the person records in the memberships are searched for matches to existing person identifiers in a distribution list. For example, the person identifiers may be searched for matches according to one or more known methods. In block 308, for the memberships that include person identifiers that are matches to the existing person identifiers, other person identifiers from these memberships are suggested to be added to the existing person identifiers in the distribution list (e.g., 206) to extend the distribution list (e.g., 208). In some embodiments, other person identifiers are suggested from the memberships that most include matches to the existing person identifiers.

In some embodiments, the person identifiers in the memberships are searched for matches to existing person identifiers (e.g., in block 306) in a distribution list of an electronic messaging (e.g., email, chat, texting, etc.), scheduling (e.g., for meetings, conferences, etc.), or collaboration (e.g., team spaces) item. For example, in the case of an email item, at runtime, when an email client user is sending an email and has entered the names of a small number of known experts (e.g., two or more) in a distribution list field (e.g., a “To”, “Cc”, etc. field), the email client (e.g., computer 102) can then automatically search existing clusters and find out which clusters, if any, contain the names of these same experts. If such a cluster is found, then the email client will suggest names of other members of that same cluster. If the user-entered names span more than one cluster, the email client will suggest a combined list of the names of members of these clusters. By utilizing clustering, storage and runtime needs are noticeably reduced, making the operability described by method 300 executable by, e.g., desktop machines and smaller client devices.

Exemplary computer system 100, computer 102, and diagram 200 are illustrated and described with respect to various components, modules, etc. for exemplary purposes. It should be understood that other variations, combinations, or integrations of such elements that provide the same features, functions, etc. are included within the scope of embodiments of the invention.

The flowchart and/or block diagram(s) in the Figure(s) described herein illustrate the architecture, functionality, and/or operation of possible implementations of systems, methods, and/or computer program products according to various embodiments of the present invention. In this regard, each block in a flowchart or block diagram may represent a module, segment, or portion of code, which comprises one or more executable instructions for implementing the specified logical function(s). It should also be noted that, in some alternative implementations, the functions noted in a flowchart or block diagram may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in a flowchart or block diagram can be implemented by special purpose hardware-based systems that perform the specified functions or acts, or combinations of special purpose hardware and computer instructions.

The terminology used herein is for the purpose of describing exemplary embodiments and is not intended to be limiting of the present invention. As used herein, the singular forms “a”, “an”, and “the” are intended to include the plural forms as well, unless the context clearly indicates otherwise. It will be further understood that the terms “comprises”, “comprising”, “includes”, or “including” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The exemplary embodiment(s) were chosen and described in order to explain the principles of the present invention and the practical application, and to enable others of ordinary skill in the art to understand the present invention for various embodiments with various modifications as are suited to the particular use contemplated.

As will be appreciated by one skilled in the art, the present invention may be embodied as a system, method, and/or computer program product. Accordingly, the present invention may take the form of an entirely hardware embodiment, an entirely software embodiment (including firmware, resident software, micro-code, etc.), and/or or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart and/or block diagram blocks.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A method, comprising:
determining a set of clusters of person records from a data source that includes the person records, wherein the person records include attributes and person identifiers that correspond to the attributes;
determining memberships of the person records to the clusters based on a correlation of the attributes across the person records;
searching the person identifiers of the person records in the memberships for matches to existing person identifiers in a distribution list; and
for the memberships that include person identifiers that are matches to the existing person identifiers, suggesting other person identifiers from these memberships to be added to the existing person identifiers in the distribution list to extend the distribution list.

2. The method of claim 1, wherein determining the set of clusters and determining the memberships comprises executing a K-means, Fuzzy C-means, Hierarchical, or Mixture of Gaussians clustering algorithm on the data source.

3. The method of claim 1, wherein determining the set of clusters of person records comprises determining a set of clusters of person records that include attributes that are based on a lightweight directory access protocol (LDAP), a listing of project involvement, a listing of authoring of articles or publications, past or current team membership of employees, or a frequency of emailing or short-term conversations between employees.

4. The method of claim 1, wherein determining the set of clusters of person records from the data source comprises determining a set of clusters of person records obtained from a lightweight directory access protocol (LDAP) directory, a listing of project involvement, a listing of authoring of articles or publications, a listing of past or current team membership of employees, or a listing of a frequency of emailing or short-term conversations between employees.

5. The method of claim 1, wherein searching the person identifiers of the person records in the memberships for matches to the existing person identifiers in the distribution list comprises searching the person identifiers in the memberships for matches to existing person identifiers in a distribution list of an electronic messaging, scheduling, or collaboration item.

6. The method of claim 1, further comprising storing the clusters and the memberships for future searches.

7. The method of claim 1, further comprising periodically repeating determining the set of clusters and determining the memberships to update the clusters and the memberships.
